(19) United States
(12) Patent Application Publication
(10) Pub. No.: US 2014/0086595 A1
(43) Pub. Date: Mar. 27, 2014

(54) OPTICAL MIXER, OPTICAL RECEIVER, OPTICAL MIXING METHOD AND PRODUCTION METHOD FOR OPTICAL MIXER

(71) Applicant: Hiroyuki Yamazaki, Tokyo (JP)

(72) Inventor: Hiroyuki Yamazaki, Tokyo (JP)

(73) Assignee: NEC CORPORATION, Tokyo (JP)

(21) Appl. No.: 14/115,939

(22) PCT Filed: May 7, 2012
(86) PCT No.: PCT/JP2012/062243

§ 371 Date: Nov. 6, 2013

(30) Foreign Application Priority Data
May 11, 2011 (JP) 2011-106390

(51) Int. Cl. H04B 10/61

(52) U.S. Cl. CPC H04B 10/616
USPC 398/214; 156/280

(57) ABSTRACT

In order to provide a high performance optical mixer having good yield, an optical mixer comprises: a first light branching means that branches a first input light into a plurality of first lights including a first output light and a second output light, and outputs the first lights; a second light branching means that branches a second input light into a plurality of second lights including a third output light and a fourth output light, and outputs the second lights; and a first light coupling and branching means and a second light coupling and branching means that couple the first and the third output lights and the second and the fourth output lights respectively, and branching the coupled lights into at least two, and outputting each of the branched lights as a coupled-and-branched light, wherein propagation paths for the third and the fourth output lights comprise widths that cause a prescribed optical path length difference to occur between the third and the fourth output lights, and propagation path lengths for the first and the second output lights are approximately equal and propagation path lengths for the third and the fourth output lights are approximately equal.

### TECHNICAL FIELD

The present invention relates to an optical mixer, an optical receiver, an optical mixing method and a production method for an optical mixer and in particular, relates to an optical mixer, an optical receiver, an optical mixing method and a production method for an optical mixer used when receiving a digital coherent signal.

### BACKGROUND ART

With a rise of transmission rate of optical communication system, investigations of the optical communication system that enables large capacity and high-speed communication more efficiently have been carried out energetically. Among them, DP-QPSK is a modulation method whose adoption is regarded as a favorite one in 100GE transmission device. DP-QPSK is an abbreviation of dual-polarization quadrature phase shift keying. Also, 100GE is an abbreviation of 100 Gigabit Ethernet (registered trademark).

For demodulation of a signal light modulated by DP-QPSK, a digital coherent receiving method is used. In the digital coherent receiving method, a received signal light (received light) and a local oscillation light (local light) having optical frequency approximately the same as the received light are combined by an optical mixer called a 90-degree hybrid. Then, an output of the 90-degree hybrid is received by a light receiving element (photo diode, PD). The light receiving element outputs a beat signal of the received light and the local light to a signal processing circuit. The signal processing circuit performs calculation processing of the beat signal that PD outputted and demodulates data.

In an optical receiver of the digital coherent receiving method, a light signal modulated by DP-QPSK is separated into polarized wave components crossing at right angles each other by PBS. Two received polarization-separated lights are inputted independently to the 90-degree hybrid formed out of an optical waveguide as a TE (transverse electric) signal and a TM (transverse magnetic) signal respectively. The inputted TE signal and the TM signal are mixed with the local light.

FIG. 8 is a figure showing a structure of a 90-degree hybrid 10 related to the present invention. The 90-degree hybrid 10 is configured by two interferometers 11 and 12. Both the interferometers 11 and 12 are MZI (Mach-Zehnder interferometer).

In FIG. 8, the polarization-separated TE signal formed from the received light is inputted to an input port 31 of the 90-degree hybrid 10. On the other hand, the polarization-separated TM signal component formed from the received light is inputted to an input port 33 of the 90-degree hybrid 10.

The local light outputted from a local oscillation light source installed outside the 90-degree hybrid is inputted to an input port 32 of the 90-degree hybrid 10.

The TE signal inputted to the input port 31 is inputted to an input light coupler 21. The input light coupler 21 outputs the inputted TE signal to an arm 41 and an arm 42. The TM signal inputted to the input port 33 is inputted to an input light coupler 24. The input light coupler 24 outputs the inputted TM signal to an arm 47 and an arm 48.

The local light inputted to the input port 32 is branched into two lights and inputted to an input light coupler 22 and an input light coupler 23. The input light coupler 22 outputs the inputted local light to an arm 43 and an arm 44. The input light coupler 23 outputs the inputted local light to an arm 45 and an arm 46.

An output light coupler 25 couples the TE signal inputted from the arm 41 and the local light inputted from the arm 43, and outputs the coupled signal to output ports 51 and 52.

An output light coupler 26 couples the TE signal inputted from the arm 42 and the local light inputted from the arm 44, and outputs the coupled signal to output ports 53 and 54.

An output light coupler 27 couples the local light inputted from the arm 45 and the TM signal inputted from the arm 47, and outputs the coupled signal to output ports 55 and 56.

An output light coupler 28 couples the local light inputted from the arm 46 and the TM signal inputted from the arm 48, and outputs the coupled signal to output ports 57 and 58.

The interferometers 11 and 12 that configure the 90-degree hybrid 10 are asymmetric MZI. That is, in the interferometer 11, lengths of the arms 41 and 42 are the same, and length of the arm 44 is longer than that of the arm 43 by ¼ wavelength (π/2) when converted to a wavelength of the signal light that passes the interferometer 11. And also in the interferometer 12, length of the arms 45 and 46 are the same, and length of the arm 48 is longer than that of the arm 47 by ¼ wavelength (π/2) when converted to a wavelength of the signal light that passes interferometer 12.

Then, in the arm 44 and the arm 48, by changing the physical lengths of waveguides from the arm 43 and the arm 47, phase differences are caused to the propagating lights. For this reason, in the arm 44 and the arm 48, bends 60 and 61 are installed in the arms.

Patent literature (PTL) 1 related to the present invention describes phase control of an interferometer by a waveguide. The target of PTL 1 is to realize an optical filter by combining the MZI in multiple stages. Also, PTL 2 describes a 90-degree hybrid using a space optical system. PTL 2 discloses, for phase control in the space optical system, a structure for controlling a physical position or for inserting materials whose refractive index is different in an optical path. Further, PTL 3 describes a phase control method in an MZI interferometer configured by a waveguide.

### CITATION LIST

### Patent Literature

[PTL 1] Japanese Unexamined Patent Application Publication No. 2010-134224

[PTL 2] Japanese Unexamined Patent Application Publication No. 2010-237300

[PTL 3] Japanese Unexamined Patent Application Publication No. 1995-281041

### DISCLOSURE OF INVENTION

### Technical Problem

As has been explained in FIG. 8, in the 90-degree hybrid 10, in order to make the physical lengths of the arm 44 and the arm 48 longer, the bends 60 and 61 are installed in the arms. And when the bends 60 and 61 are formed, a part with small radius of curvature occurs in the waveguide.

However, when the bends 60 and 61 are installed in the arms 44 and 48 of the 90-degree hybrid 10 explained in FIG. 8, there is a case when loss of the 90-degree hybrid may increase by radiation from the part with small radius of curvature. Also, by configuring a part of the arm from the waveguide different in shape than other arms, symmetry of the structure of the optical waveguide declines, and as a result, problem occurs that there is a case that yield of the product may fall.

In relation to such problems, although PTL 1 describes phase control of an interferometer by a waveguide, PTL 1 does not describe at all phase control in the 90-degree hybrid. Also, PTL 2 is one that discloses a technology that relates to a structure of the 90 degree hybrid using the space optical system, however, PTL 2 does not describe a structure that controls a phase of an optical mixer configured by a waveguide. Further, a technology described in PTL 3 does not describe at all a structure that performs phase control of the received light in the 90-degree hybrid, like PTL 1.

The object of the present invention is to provide a technology for solving the problems mentioned above and for realizing an optical mixer that can be applied to the 90-degree hybrid.

### Solution to Problem

An optical mixer of the present invention includes: a first light branching means for branching a first input light into a plurality of first lights including a first output light and a second output light, and outputs the first lights; a second light branching means for branching a second input light into a plurality of second lights including a third output light and a fourth output light, and outputs the second lights; and a first light coupling and branching means and a second light coupling and branching means for coupling the first and the third output lights and the second and the fourth output lights respectively and branching the coupled lights into at least two, and outputting each of the branched lights as a coupled-and-branched light, wherein propagation paths for the third and the fourth output lights includes widths that cause a prescribed optical path length difference to occur between the third and the fourth output lights, propagation path lengths for the first and the second output lights are approximately equal and propagation path lengths for the third and the fourth output lights are approximately equal.

An optical mixing method of the present invention includes: branching a first input light into a plurality of first lights including a first output light and a second output light, and outputting the first lights by a first light branching means; branching a second input light into a plurality of second lights including a third output light and a fourth output light, and outputting the second light by a second light branching means; coupling the first and the third output lights and branching the coupled lights into at least two by a first light coupling and branching means; coupling the second and the fourth output lights and branching the coupled light into at least two by a second light coupling and branching means; setting widths of propagation paths for the third and fourth output lights to cause a prescribed optical path length difference between the third and the fourth output lights; setting propagation path lengths for the first and second output lights to be approximately equal; and setting propagation path lengths for the third and the fourth output lights to be approximately equal.

A production method of an optical mixer of the present invention includes: a step for forming a first clad layer on a substrate; a step for laminating a core layer on the first clad layer; a step for patterning the core layer and forming a core; and a step for covering the core by a second clad layer having a same refractive index as the first clad; wherein the patterning of the core layer uses a mask pattern forming a waveguide whose structure includes: a first light branching means for branching a first input light into a plurality of first lights including a first output light and a second output light and outputs the first lights; a second light branching means for branching a second input light into a plurality of second lights including a third output light and a fourth output light, and outputs the second lights; and a first light coupling and branching means and a second light coupling and branching means for coupling the first and the third output lights and the second and the fourth output lights respectively and branching the coupled lights into at least two, and outputting each of the branched lights as a coupled-and-branched light; and wherein propagation paths for the third and the fourth output lights include widths that cause a prescribed optical path length difference to occur between the third and fourth output lights and propagation path lengths for the first and the second output lights are approximately equal and propagation path lengths for the third and the fourth output lights are approximately equal.

### Advantageous Effects of Invention

The present invention has an effect that a high-performance optical mixer whose production is easy can be realized.

### BRIEF DESCRIPTION OF DRAWINGS

FIG. 1 A figure showing a structure of an optical mixer of the first exemplary embodiment

FIG. 2 A figure showing calculation results of respective amount of change of equivalent refractive index difference and phase difference in case width of a waveguide is changed

FIG. 3 A figure showing a structure of an optical mixer of the second exemplary embodiment

FIG. 4 A figure showing a structure of an arm of an optical mixer of a modified example of the second exemplary embodiment

FIG. 5 A figure showing a structure of an optical mixer of the third exemplary embodiment

FIG. 6 A figure showing a structure of an optical mixer of the fourth exemplary embodiment

FIG. 7 A figure showing a structure of an optical mixer of the fifth exemplary embodiment

FIG. 8 A figure showing a structure of a 90-degree hybrid related to the present invention

### DESCRIPTION OF EMBODIMENTS

Generally, phase of a light after passing an optical waveguide changes depending on a wavelength of the light that passes the optical waveguide, an equivalent refractive index of the optical waveguide or an optical path length of the optical waveguide. Also, the equivalent refractive index of the optical waveguide changes depending on a width of the waveguide. In each exemplary embodiment explained below, an optical mixer will be explained that changes an optical path length of an optical waveguide utilizing a change in an equivalent refractive index caused by changing a width of an arm and, as a result, enables control of phase of the light that passes the optical waveguide.

### The First Exemplary Embodiment

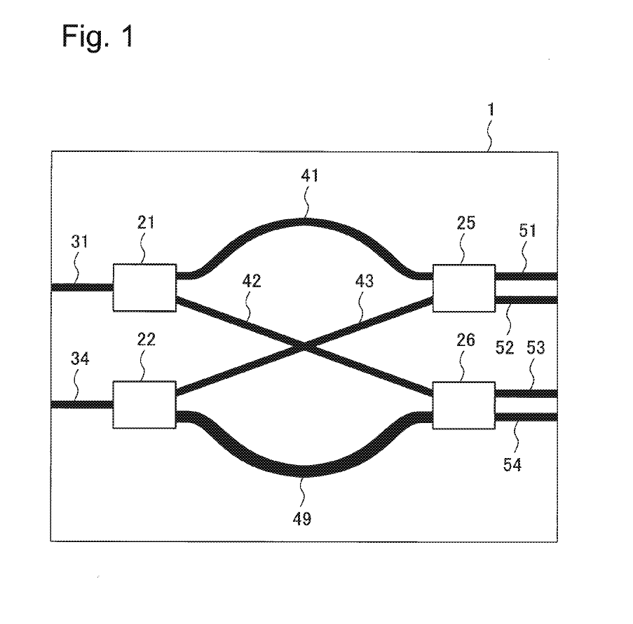

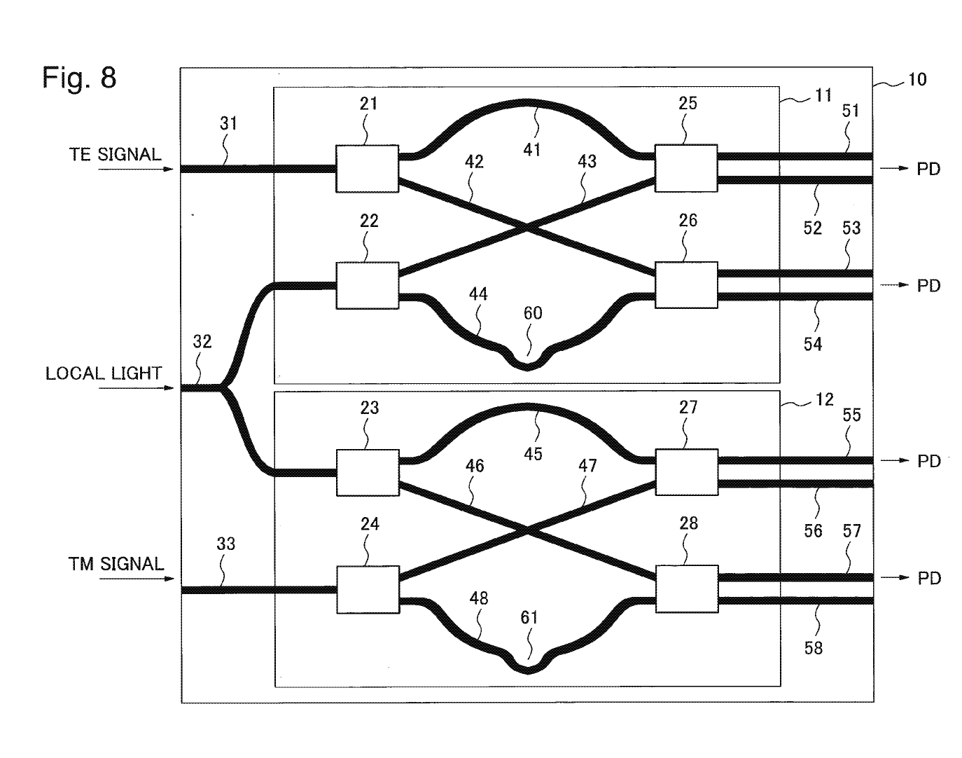

FIG. 1 is a figure showing a structure of the first exemplary embodiment of an optical mixer of the present invention. An optical mixer 1 includes a same structure as the optical mixer 11 except for including an arm 49 in place of the arm 44 in the optical mixer 11 explained in FIG. 8. Further, in FIG. 1, elements including the same function and structure as FIG. 8 are assigned the identical reference signs.

In the optical mixer 1, a first input light is inputted to the input port 31, and a second input light is inputted to an input port 34. The first input light is branched in the input light coupler 21 and propagates in the arms 41 and 42, and inputted to the output light coupler 25 and the optical coupler 26 respectively. The second input light is branched in the input light coupler 22 and propagates in the arm 43 and the arm 49, and inputted to the output light couplers 25 and 26 respectively.

The output light coupler 25 combines the first input light that propagated in the arm 41 and the second input light that propagated in the arm 43, and outputs first and second output lights to the output ports 51 and 52.

The output light coupler 26 combines the first input light that propagated in the arm 42 and the second input light that propagated in the arm 49, and outputs third and fourth output lights to the output ports 53 and 54.

In the optical mixer 1 shown in FIG. 1, lengths of the arm 41 and the arm 42 are equal, and lengths of the arm 43 and the arm 49 are equal. And the optical mixer 1, by making a width of the arm 49 different from a width of the arm 43, causes a phase difference to occur between the arm 43 and the arm 49 for the second input light.

Setting procedure of phase difference in the arm 49 of the optical mixer will be explained below. Generally, if a wavelength of light that propagates in an arm is λ, then phase difference Δφ between an arm of MZI of length L1 and an equivalent refractive index n1 and an arm of MZI of length L2 and an equivalent refractive index n2 can be obtained by the following formula.

Δφ=2π(n1×L1−n2×L2)/λ (1)

In formula (1), if a difference between the equivalent refractive indices n1−n2 is made Δn, and the arm lengths L1 and L2 that configure an interferometer are made equal, that is, L1=L2=L, then the following formula (2) is obtained.

Δφ=2π(Δn×L)/λ (2)

In this case, the difference Δn between the equivalent refractive indices of waveguides necessary to cause a phase change of π/2 can be obtained from the following formula derived from formula (2).

Δn=λ/4L (3)

For example, if L=2 mm, Δn is obtained from formula (2) as 1.94×10⁻⁴ for a wavelength of 1.55 μm.

Accordingly, in order to cause the phase difference of, for example, π/2 between the arm 43 and the arm 49 of an optical interferometer 1, it can be understood that waveguides should be made so that the difference between the equivalent refractive indices of the arm 43 and the arm 49 will be about 1.94×10⁻⁴.

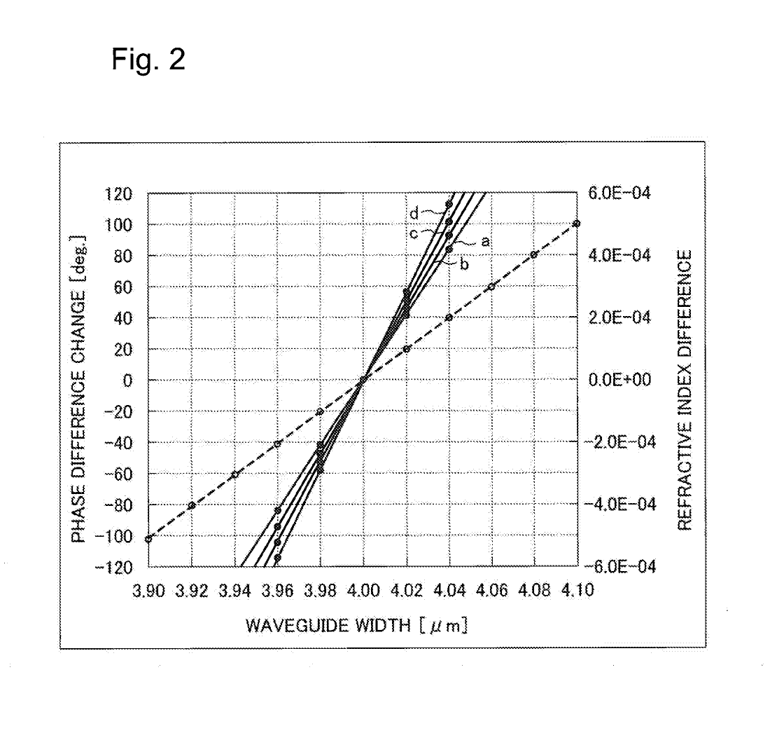

Relation between a width of a waveguide and an equivalent refractive index can be obtained by numerical calculation. FIG. 2 is a graph of relation between the width of a waveguide and, changes of the equivalent refractive index difference and the phase difference that occurs in the waveguide for a case of the wavelength of 1.55 μm, obtained by numerical calculation. In FIG. 2, a horizontal axis is the width (μm) of a waveguide, and a vertical axis is an amount of change of the equivalent refractive index difference and an amount of change of the phase difference (deg.). FIG. 2 shows, by making a waveguide with an width of 4 μm as a standard (amount of changes of equivalent refractive index difference and phase difference=0), calculation result of respective amount of changes of the equivalent refractive index difference and the phase difference in case the width of the waveguide is changed between 3.9 μm and 4.1 μm. A dotted line of FIG. 2 shows the amount of change of the equivalent refractive index difference. Also, four solid lines a to d of FIG. 2 show calculation results of the phase difference in case the lengths of the waveguide are 1800 μm (a), 2000 μm (b), 2200 μm (c) and 2400 μm (d) respectively.

From FIG. 2, it can be found that, for example, when the solid line b is focused, for a waveguide of the length of 2 mm (2000 μm) and the width of 4 μm, the width of a waveguide of the same length and that causes a phase difference of 90 degrees (π/2) is about 4.04 μm or about 3.96 μm. That is, for example, in the optical mixer 1 shown in FIG. 1, the lengths of the arms 41 to 43 and 49 are all set to 2 mm, the width of the arms 41 to 43 are set to 4 μm, and the width of the arm 49 is set to 4.04 μm. By configuring as above, the difference between the phase at the output light coupler 26 of the light that propagates in the arm 49 and the phase at the output light coupler 25 of the light that propagates in the arm 43 can be made π/2.

Here, when the width of the arm 49 is set to 4 μm and the width of the arm 43 is set to 3.96 μm, the phase difference of π/2 can be caused between the light that propagates in the arm 49 and the light that propagates in the arm 43.

Also, in order to cause a prescribed phase difference, waveguides may be formed so that the width of the arm 49 will be narrower than the width of the arm 43. That is, even when the width of the arm 43 is set to 4 μm and the width of the arm 49 is set to 3.96 μm, the phase difference of π/2 can be caused between the light that propagates in the arm 49 and the light that propagates in the arm 43.

In the optical mixer 1, as shown in the example of computation mentioned above, the lengths of the arms 41 to 43 and the arm 49 may all be made equal. And by forming waveguides so that the width will be made different from the width of the arm 43 only for the arm 49 to which the phase difference is to be given to the light that passes, it becomes possible to configure an asymmetric MZI that includes the same function as the optical mixer 11 explained in FIG. 8.

Thus, the optical mixer of the first exemplary embodiment controls, by changing the width of a waveguide of an arm and controlling the equivalent refractive index, the phase of the light that passes the arm concerned. For this reason, compared with a structure that causes a phase difference by including a bend in an arm, it has an effect that, without increasing optical loss by a steep curve of a waveguide, a high-performance optical mixer can be realized. Also, the optical mixer of the first exemplary embodiment can make the lengths of the arms all equal. Accordingly, since symmetry of the construction of the optical mixer increases compared with the structure including the bend in the arm, the optical mixer of the first exemplary embodiment also has an effect that the production yield improves.

Further, the optical mixer explained in the first exemplary embodiment can operate as a 90-degree hybrid of a digital coherent receiver by inputting a QPSK-modulated light signal as the first input light, and inputting a local oscillation light as the second input light.

Also, an optical receiver may be configured by adding PD, ADC (analog to digital converter) and a signal processing circuit to the optical mixer 1. The PD receives each of the output lights outputted by the optical mixer 1 to the output ports 51 to 54 and outputs the received signals as electric signals. ADC applies analog-to-digital conversion to the electric signals outputted by the PDs. The signal processing circuit performs calculation processing to an output of ADC and demodulates data included in the electric signal.

Further, the optical mixer explained in the first exemplary embodiment can be produced by the following procedure. That is, a first clad layer is formed on a substrate, and a core layer is laminated on the first clad layer. And by a mask pattern of the structure explained in FIG. 1, the core layer is patterned and a core is formed. Further, the core is covered with a second clad layer having the same refractive index as the first clad.

### The Second Exemplary Embodiment

In the optical interferometer of the first exemplary embodiment, in case a waveguide width of an arm is increased or decreased compared with widths of other arms, the waveguide width may not be changed over a full length of the arm. In case a prescribed phase difference is obtained, the waveguide width may be changed only for a part of the arm in longitudinal direction.

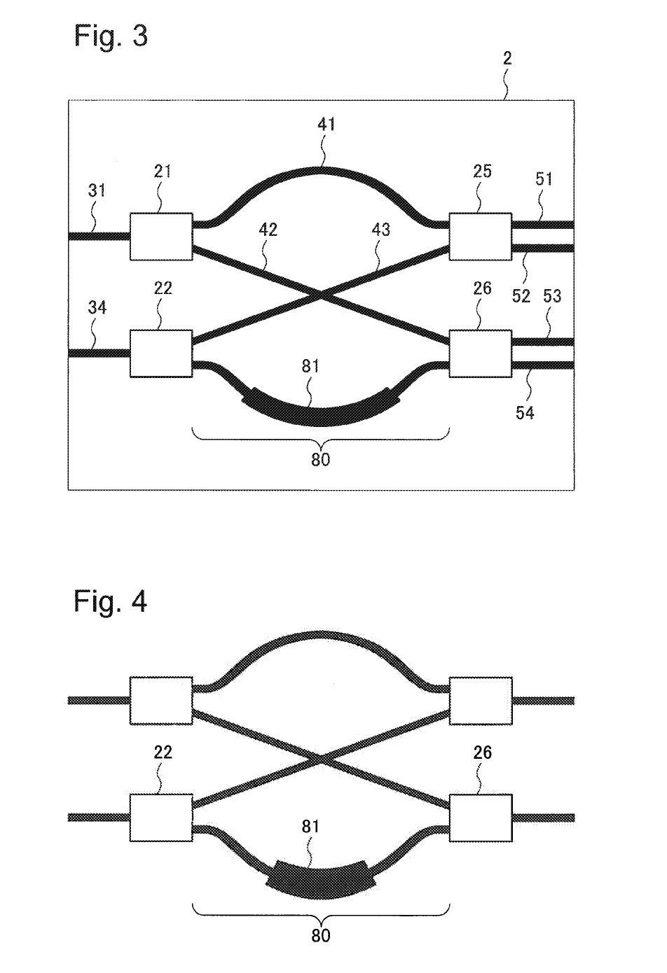

FIG. 3 is a figure showing a structure of an optical mixer 2 of the second exemplary embodiment of the present invention. The optical mixer 2 includes an arm 80 in place of the arm 50 compared with the optical mixer 1 explained in the first exemplary embodiment. In the optical mixer 2 shown in FIG. 3, the identical reference signs are assigned to the elements including the same function and structure as the optical mixer 1 shown in FIG. 1.

As for the arm 80 included in the optical mixer 2 shown in FIG. 3, only an arm central part 81 has a width different from the arm 43 and end parts of the arm 80 have widths identical with the arm 43.

FIG. 4 is a figure showing a structure of the arm 80 of a modified example of the optical mixer of the second exemplary embodiment. By making the difference between the widths of the waveguides larger, it is possible to obtain the change of the identical phase difference by making the length of the arm central part 81 shorter.

The optical mixers of the second exemplary embodiment and of the modified example thus configured, like the optical mixer of the first exemplary embodiment, by changing the width of the waveguide of the arm and controlling the equivalent refractive index, control the phase of the light that passes the arm concerned. For this reason, compared with a structure that causes a phase difference by including a bend in an arm, the optical loss does not increase by a steep curve of a waveguide. And the optical mixers of the second exemplary embodiment and of the modified example have an effect that, compared with the structure including the bend in the arm, the symmetry of the construction of the optical mixer increases and the production yield of the optical mixer improves.

### The Third Exemplary Embodiment

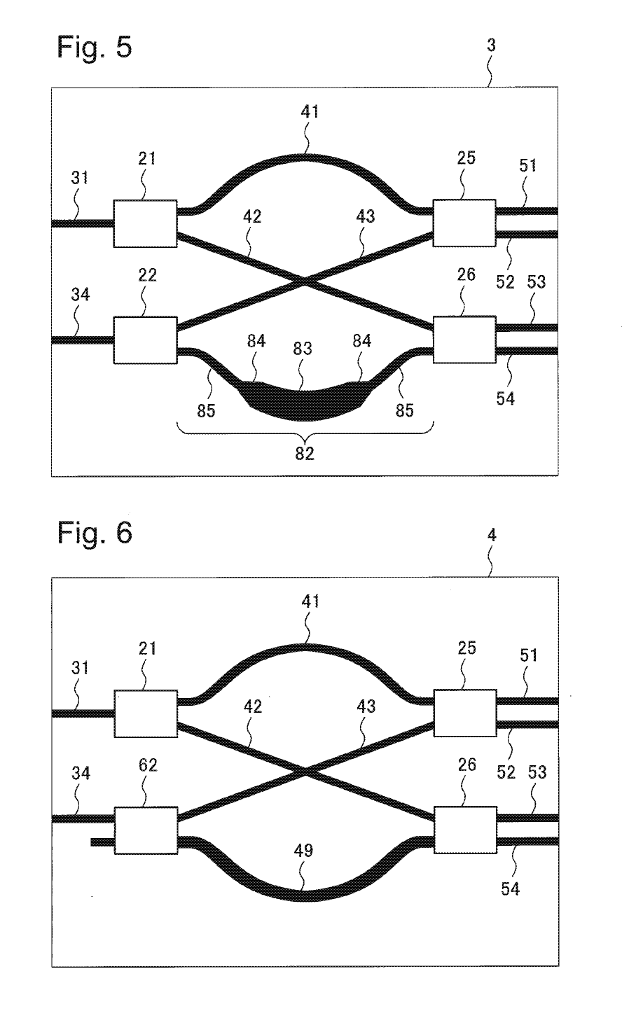

FIG. 5 is a figure showing a structure of an optical mixer 3 of the third exemplary embodiment of the present invention. In the optical mixer 3 shown in FIG. 5, the identical reference signs are assigned to the elements including the same function and structure as the optical mixers 1 and 2 shown in FIG. 1 and FIG. 3.

The optical mixer 3 includes an arm 82 in place of the arm 80 compared with the optical mixer 2 explained in the second exemplary embodiment. In the arm 82, a central part 83 of the arm 82 and end parts 85 of the arm 82 are connected using a tapered waveguide 84. Accordingly, the optical mixer of the third exemplary embodiment has, in addition to the effects explained in the first and the second exemplary embodiments, an further effect that the optical mixer can reduce optical loss accompanied by a steep change of a waveguide width.

### The Fourth Exemplary Embodiment

FIG. 6 is a figure showing a structure of an optical mixer 4 of the fourth exemplary embodiment of the present invention. The optical mixer 4 differs, compared with the optical mixer 1 explained in the first exemplary embodiment, in a point that the optical mixer 4 includes a multimode interference element 62 as the input light coupler 22.

In FIG. 6, the multimode interference element 62 transmits the second input light inputted from the input port 34 to the arms 43 and 49. By an action of the multimode interference element 62, the lights outputted to the arm 43 and the arm 49 have a prescribed phase difference. Accordingly, in case the multimode interference element 62 outputs the lights to the arms 43 and 49 with exactly the phase difference of π/2, there is no need to add the phase difference by the arm 49 in order to cause the phase difference of π/2 to occur at the output light couplers 25 and 26 for the light inputted from the input port 34.

However, by variation of characteristics of the multimode interference element 62, there is a case when the phase difference between the lights outputted from the multimode interference element 62 to the arm 43 and the arm 49 may not be exactly π/2. Such variation of characteristics of the multimode interference element 62 is occurred, for example, by an error in the production.

For this reason, in the fourth exemplary embodiment, the optical mixer 4 adjusts the phase of the light that passes the arm 49 so that the phase difference of the light inputted from the input port 34 will be a prescribed value at the output light coupler 25 and the output light coupler 26.

For example, at an output of the multimode interference element 62, suppose that the phase of the light outputted to the arm 49 advances by (π/2)+Δθ (Δθ>0) compared with the phase of the light outputted to the arm 43 due to the variation of characteristics of the multimode interference element 62. Δθ is a phase error of the multimode interference element 62. In this case, by delaying the phase of the light at the arm 49 by only Δθ, the phase difference between the lights at the output light couplers 25 and 26 can be made π/2.

Thus, by further adjusting the phase of the light outputted from the multimode interference element by the arm, the optical mixer of the fourth exemplary embodiment can match the phase difference between the lights inputted to the output light couplers with a prescribed value exactly. Accordingly, the optical mixer of the fourth exemplary embodiment has, in addition to the effect of the optical mixer of the first exemplary embodiment, an effect that the optical mixer can reduce influence of the phase error caused by the variation in the production of the multimode interference element.

In the fourth exemplary embodiment, a case when the multimode interference element is employed as the input light coupler in the optical mixer of the first exemplary embodiment has been explained. And also in the optical mixers explained in the second and the third exemplary embodiments, the multimode interference element can be employed as the input light coupler. And in case a multimode interference element is employed as the input light coupler in the second or the third exemplary embodiment, in addition to the effect of each of the exemplary embodiments, the same effect as the fourth exemplary embodiment that the influence of the phase error of the multimode interference element can be reduced, is obtained.

### The Fifth Exemplary Embodiment

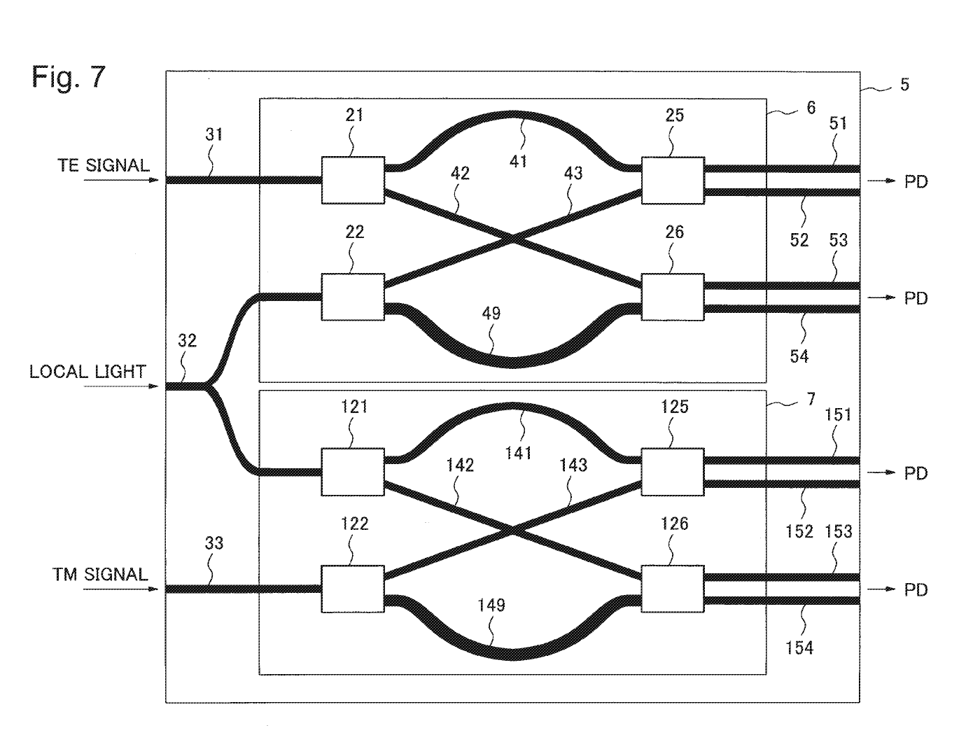

FIG. 7 is a figure showing a structure of an optical mixer of the fifth exemplary embodiment of the present invention. The optical mixer 5 shown in FIG. 7 is one that arranges two optical mixers 1 explained in the first exemplary embodiment in parallel as optical mixers 6 and 7 and configured them as a 90-degrees hybrid used for demodulation of DP-QPSK signal.

In the optical mixer 5, a polarization-separated TE signal formed from a received light is inputted to the input port 31, and a local light is inputted to the input port 32. Also, a polarization-separated TM signal formed from the received light is inputted to the input port 33.

The TE signal is branched in the input light coupler 21 and each of the branched signals propagates in the arm 41 or the arm 42, and is inputted to the output light coupler 25 or the output light coupler 26 respectively. The TM signal is branched in an input light coupler 122 and each of the branched signals propagates in an arm 143 or an arm 149, and is inputted to an output light coupler 125 or an output light coupler 126 respectively.

The local light is branched in the input light coupler 22 and an input light coupler 121. The local lights branched in the input light coupler 22 propagate in the arm 43 and the arm 49, and are inputted to the output light coupler 25 and the output light coupler 26 respectively. The local lights branched in the input light coupler 121 propagate in an arm 141 and an arm 142, and are inputted to the output light coupler 125 and the output light coupler 126 respectively.

The output light coupler 25 combines the TE signal that propagated in the arm 41 and the local light that propagated in the arm 43, and outputs an output light to the output ports 51 and 52.

The output light coupler 26 combines the TE signal that propagated in the arm 42 and the local light that propagated in the arm 49, and outputs an output light to the output ports 53 and 54.

The output light coupler 125 combines the TE signal that propagated in the arm 141 and the local light that propagated in the arm 143, and outputs an output light to the output ports 151 and 152.

The output light coupler 126 combines the TE signal that propagated in the arm 142 and the local light that propagated in the arm 149, and outputs an output light to the output ports 153 and 154.

In the optical mixer 5 shown in FIG. 7, lengths of the arm 41 and the arm 42 are equal, and the lengths of the arm 43 and the arm 49 are equal. Further, lengths of the arm 141 and the arm 142 are equal, and lengths of the arm 143 and the arm 149 are equal. Additionally, lengths of all the arms may be made equal.

And widths of the arms 49 and 149 are defined so that at the output light coupler 26 and the output light coupler 126, a phase difference between the TE signal or the TM signal and the local light will be π/2 respectively. The widths of the arm 49 and the arm 149 are determined by the procedure explained in the first exemplary embodiment.

By including such a structure, the optical mixer 5 generates mixed signals of the local light, and the polarization-separated TM signal or the polarization-separated TE signal formed from the DP-QPSK modulated received light at the output light couplers.

That is, the output light couplers 25 and 26 mix the TE signal and the local light. And phases of the local light against the TE signal are different by π/2 between the output light coupler 25 and the output light coupler 26. Similarly, the output light couplers 125 and 126 mix the TM signal and the local light. And phases of the local light against the TM signal are different for π/2 at the output light coupler 125 and the output light coupler 126.

The optical mixer of the fifth exemplary embodiment explained above controls, like the optical mixer of the first exemplary embodiment, by changing the width of the waveguide of the arm and controlling the equivalent refractive index, the phase of the light that passes the arm concerned. For this reason, compared with a structure that causes a phase difference by including a bend in an arm, the optical loss does not increase by a steep curve of a waveguide.

As a result, the optical mixer of the fifth exemplary embodiment can realize a high performance optical mixer having good yield for making the signal for which DP-QPSK modulation is performed and the local light interfere.

Incidentally, an optical receiver may be configured by adding PD, ADC and a signal processing circuit to the optical mixer 5. The PD receives each of the output lights outputted to the output ports 51-54 and 151-154 by the optical mixer 5 and outputs the received signals as electric signals. ADC applies analog-to-digital conversion to the electric signals outputted by the PD. The signal processing circuit performs calculation processing to an output of ADC and demodulates data included in the electric signal.

Incidentally, in the fifth exemplary embodiment, the optical mixers 6 and 7 may be replaced by any one of the optical mixers 2 to 4 explained in the second to the fourth exemplary embodiments. In this case, it is clear that any of the effect that has been explained in the second to the fourth exemplary embodiments corresponding to the replaced optical mixer is obtained together.

As above, although exemplary embodiments of the present invention have been explained with reference to the first to the fifth exemplary embodiments, embodiments to which the present invention is applicable are not limited to the exemplary embodiments mentioned above. Various changes that a person skilled in the art can understand within the scope of the present invention can be performed in the structure and detail explanation of the present invention.

This application claims priority based on Japanese Patent Application No. 2011-106390 filed on May 11, 2011 and the disclosure thereof is incorporated herein in its entirety.

### REFERENCE SIGNS LIST

1-7 Optical mixer
21-24, 121, 122 Input light coupler
25-28, 125, 126 Output light coupler
31-34 Input port
41-49, 80, 82, 141-143, 149 Arm
51-58, 151-154 Output port
62 Multimode interference element
81, 83 Arm central part
84 Tapered waveguide
85 Arm end part

1. An optical mixer comprising:
a first light branching unit that branches a first input light into a plurality of first lights including a first output light and a second output light, and outputs the first lights;
a second light branching unit that branches a second input light into a plurality of second lights including a third output light and a fourth output light and outputs the second lights; and
a first light coupling and branching unit and a second light coupling and branching unit that couple the first and the third output lights and the second and the fourth output lights respectively and branch the coupled lights into at least two, and output each of the branched lights as a coupled-and-branched light, wherein
propagation paths for the third and the fourth output lights comprise widths that cause a prescribed optical path length difference between the third and the fourth output lights, propagation path lengths for the first and the second output lights are approximately equal, and propagation path lengths for the third and the fourth output lights are approximately equal.

2. The optical mixer according to claim 1, wherein a part where the width of the propagation path for the third or the fourth output light changes is configured so that the width of the propagation path may change continuously.

3. The optical mixer according to claim 1, wherein the optical path length difference causes a phase difference of π/2 between the third and fourth output lights.

4. The optical mixer according to claim 1, wherein sum of the phase difference between the third output light and the fourth output light at outputs of the second light branching unit and the phase difference caused by the path length difference between the third output light and the fourth output light is π/2.

5. The optical mixer according to claim 1, wherein the optical path length difference is defined based on the difference between a phase of the third output light and a phase of the fourth output light at the outputs of the second light branching unit.

6. An optical mixer comprising: a first optical mixer and a second optical mixer according to claim 1, wherein configured such that
a TE (transverse electric) component of a received light is inputted to the first light branching unit of the first optical mixer, and a local oscillation light is inputted to the second light branching unit of the first optical mixer; and
the local oscillation light is inputted to the first light branching unit of the second optical mixer, and a TM (transverse magnetic) component of the received light is inputted to the second light branching unit of the second optical mixer.

7. An optical receiver comprising:
an optical mixer according to claim 1;
a PD (photo diode) that receives each of the coupled-and-branched lights that the first light coupling and branching unit and the second light coupling and branching unit which are comprised by the optical mixer output, and outputs the received light as an electric signal;
an ADC (analog to digital converter) that apples analog-to-digital conversion to the electric signal; and
a signal processing circuit that performs calculation processing to an output of the ADC and demodulates data included in the electric signal.

8. An optical mixing method comprising:
branching a first input light into a plurality of first lights including a first output light and a second output light, and outputting the first lights by a first light branching means;
branching a second input light into a plurality of second lights including a third output light and a fourth output light, and outputting the second lights by a second light branching means;
coupling the first and the third output lights and branching the coupled lights into at least two by a first light coupling and branching means;
coupling the second and the fourth output lights and branching the coupled lights into at least two by a second light coupling and branching means;
setting widths of propagation paths for the third and fourth output lights to cause a prescribed optical path length difference between the third and the fourth output lights;
setting propagation path lengths for the first and the second output lights to be approximately equal; and
setting propagation path lengths for the third and the fourth output lights to be approximately equal.

9. The optical mixing method according to claim 8 further comprising:
setting sum of a phase difference between the third output light and the fourth output light at outputs of the second light branching means and a phase difference caused by the path length difference between the third output light and the fourth output light to π/2.

10. A production method of an optical mixer comprising:
forming a first clad layer on a substrate;
laminating a core layer on the first clad layer;
patterning the core layer and forming a core; and
covering the core by a second clad layer having a same refractive index as the first clad, wherein
the patterning of the core layer uses a mask pattern forming a waveguide whose structure includes:
a first light branching unit that branches a first input light into a plurality of first lights including a first output light and a second output light, and outputs the first lights;
a second light branching unit that branches a second input light into a plurality of second lights including a third output light and a fourth output light, and outputs the second lights; and
a first and a second light coupling and branching units that couple the first and the third output lights and the second and the fourth output lights respectively, and branch the coupled lights into at least two, and output each as a coupled-and-branched light; and wherein
propagation paths for the third and the fourth output lights have widths having a prescribed optical path length difference, and propagation path lengths for the first and the second output lights are approximately equal and propagation path lengths for the third and the fourth output lights are approximately equal.
